(19) United States
(12) Patent Application Publication
(10) Pub. No.: US 2015/0114090 A1
(43) Pub. Date: Apr. 30, 2015

(54) MOBILE DEVICE AND WATERPROOF TEST METHOD

(71) Applicant: LG ELECTRONICS INC., Seoul (KR)

(72) Inventor: KENICHI FUKUDA, Tokyo (JP)

(73) Assignee: LG ELECTRONICS INC.

(21) Appl. No.: 14/524,702

(22) Filed: Oct. 27, 2014

(30) Foreign Application Priority Data
Oct. 29, 2013 (KR) 10-2013-0129623

(51) Int. Cl. G06F 1/16; F21V 33/00; G01M 3/26

(52) U.S. Cl. CPC G06F 1/1656; G06F 1/1626; G01M 3/26; F21V 33/0052; F21Y 2101/02
USPC 73/40; 362/253

(57) ABSTRACT

Provided is a mobile device. The mobile device includes a battery cover having an LED hole with a size to allow at least one portion of the LED lens to pass therethrough, a lens support part disposed under the battery cover while supporting a portion of a lower surface of the LED lens, the lens support part having a ventilation hole with a predetermined size, an LED device generating light emitted through the LED lens, a waterproof tape disposed between a lower portion of the battery cover and the lens support part to prevent moisture from being penetrated, and an air vent filter which is a member allowing air to be ventilated through the ventilation hole, the air vent filter being disposed under the lens support part.

### CROSS-REFERENCE TO RELATED APPLICATIONS

Pursuant to 35 U.S.C. §119(a), this application claims the benefit of earlier filing date and right of priority to Korean Patent Application No. 10-2013-0129623, filed on Oct. 29, 2013, the contents of which are hereby incorporated by reference herein in its entirety.

### BACKGROUND

The present disclosure relates to a mobile device and a waterproof test method.

Recently, electronic devices having a waterproof function are being developed and released. Waterproof mobile devices such as smart phones, tablet personal computers (PCs), and the like are configured to prevent water from being permeated into a case. That is, such a mobile device has a sealed structure where a gap through which the water is permeable is sealed by using rubber, and so on.

However, in the existing waterproofing structure, there is a limitation that the mobile device significantly increases in internal pressure by a pressure applied to the mobile device due to a user's manipulation or heat generated in the mobile device.

To solve the above-described limitation, there is a structure in which the inside and the outside of the mobile device are ventilated. For example, a barometric control sheet may be used for the waterproof mobile device so as to improve the sealed structure through which air is not ventilated.

FIG. 1 is a view illustrating a rear case of a waterproof mobile device according to a related art, and FIG. 2 is a rear view of a state where a battery cover is coupled to the waterproof mobile device.

Referring to FIGS. 1 and 2, if a mobile device includes an exchangeable battery, the mobile device is constituted by a rear case 2 for protecting a circuit therein and a battery cover for covering the rear case 2. That is, when the battery cover that is a rear surface of the mobile device is separated, the rear case exists, and holes are respectively defined in the battery cover and the rear case to allow air to be ventilated between the inside and the outside of the mobile device.

Also, in the case of the waterproof mobile device, the inside of the mobile device needs to be sealed. Here, an air vent hole 10 may be defined in the rear case 2 so as to prevent an internal pressure from significantly increasing due to the sealed inner space.

A special film that is called an air vent filter may be provided on the air vent hole 10. The air vent filter may allow the air to be circulated, but prevent water from being permeated. The air vent filter is mounted to cover an inlet of the air vent hole 10 in the rear case 2.

Also, a ventilation hole 21 for ventilating has to be defined in the battery cover 20. Thus, the ventilation hole 21 together with the air vent hole 10 of the rear case 2 may prevent the internal pressure of the mobile device from abnormally increasing.

FIGS. 3 and 4 illustrate a cross-sectional structure of the mobile device in which the air vent hole and the ventilation hole are defined.

Referring to FIG. 3, an air vent filter 30 having a size that is capable of sufficiently blocking a lower outlet of the air vent hole 10 is defined in the rear case 2. In this case, as an illustrated as an arrow, air inside the mobile device passes through the air vent filter 30 to flow into a space between the battery cover 20 and the rear case 2. The air may be circulated through the ventilation hole 21 defined in the battery cover 20 as illustrated in FIG. 4.

FIG. 4 illustrates the case where the ventilation hole 21 defined in the battery cover 20 is blocked by the air vent filter 30. The air vent filter 30 may prevent water from being permeated and may allow air to pass therethrough.

If the waterproof mobile device includes an exchangeable battery, it is noted that a structure with respect to the waterproof and the ventilation is applied to all the rear case and the battery cover. The air vent hole 10 has to be defined in the rear case 2, and also the ventilation hole 21 has to be defined in the battery cover 20 so as to circulate air.

However, in a user position, a user may feel a sense of disharmony with respect to the structure in which the holes are respectively defined in the battery cover and the rear case even if the mobile device has the waterproof property. Particularly, in the current tendency to consider the exterior design of the mobile device as important, the exterior of the mobile device lacks a sense of beauty due to the exposed holes.

Also, since the ventilation hole 21 of the battery cover 20 is closed by the air vent filter 30, the ventilation hole 21 is exposed through the rear surface of the mobile device, and thus there is the risk of misplacing the air vent filter 30 due to user's carelessness.

### SUMMARY

Embodiments provide a mobile device having a waterproof function as well as a ventilation function through the inside and the outside thereof without defining a hole in an outer surface thereof.

Embodiments also provide a method of performing waterproof and ventilation tests with respect to a mobile device having waterproof and ventilation properties.

In one embodiment, mobile device includes: a light emitting diode (LED) device disposed within a mobile device; an LED lens through which light emitted from the LED device is transmitted; a cover in which an LED hole through which a portion of the LED lens is exposed, wherein the LED hole has a size that is capable of defining a gap between the lens and the cover; and a waterproof tape disposed inside the cover, wherein the LED lens includes: a lens area exposed through the LED hole; and an extension area extending from the lens, the extension area being disposed under, wherein a ventilation hole is defined in the extension area of the LED lens, and the waterproof tape is disposed between an inner surface of the cover and the extension area of the LED lens.

In another embodiment, a mobile device includes: a battery cover having an LED hole with a size to allow at least one portion of the LED lens to pass therethrough; a lens support part disposed under the battery cover while supporting a portion of a lower surface of the LED lens, the lens support part having a ventilation hole with a predetermined size; an LED device generating light emitted through the LED lens; a waterproof tape disposed between a lower portion of the battery cover and the lens support part to prevent moisture from being penetrated; and an air vent filter which is a member allowing air to be ventilated through the ventilation hole, the air vent filter being disposed under the lens support part.

The details of one or more embodiments are set forth in the accompanying drawings and the description below. Other features will be apparent from the description and drawings, and from the claims.

### BRIEF DESCRIPTION OF THE DRAWINGS

FIG. 1 is a view illustrating a rear case of a mobile device having a waterproof function.

FIG. 2 is a rear view of a state where a battery cover is coupled to the mobile device having the waterproof function.

FIGS. 3 and 4 are views of a case where air vent filters are respectively provided inside the rear case and inside the battery cover.

FIG. 5 is a view of a ventilation structure which is applied to a battery cover of a mobile device having a waterproof function according to an embodiment.

FIG. 6 is a view illustrating a structure of an air vent filter that is applicable to the current embodiment.

FIG. 7 is an enlarged view illustrating the ventilation structure of the mobile device of FIG. 5.

FIG. 8 is a view of a state where a portion of an upper surface of a light emitting diode (LED) lens is exposed through an LED hole.

FIG. 9 is a view of a state where a waterproof test is performed on the mobile device.

FIGS. 10 to 13 are views illustrating a method of performing a waterproof test with respect to the mobile device having the ventilation structure of the current embodiment.

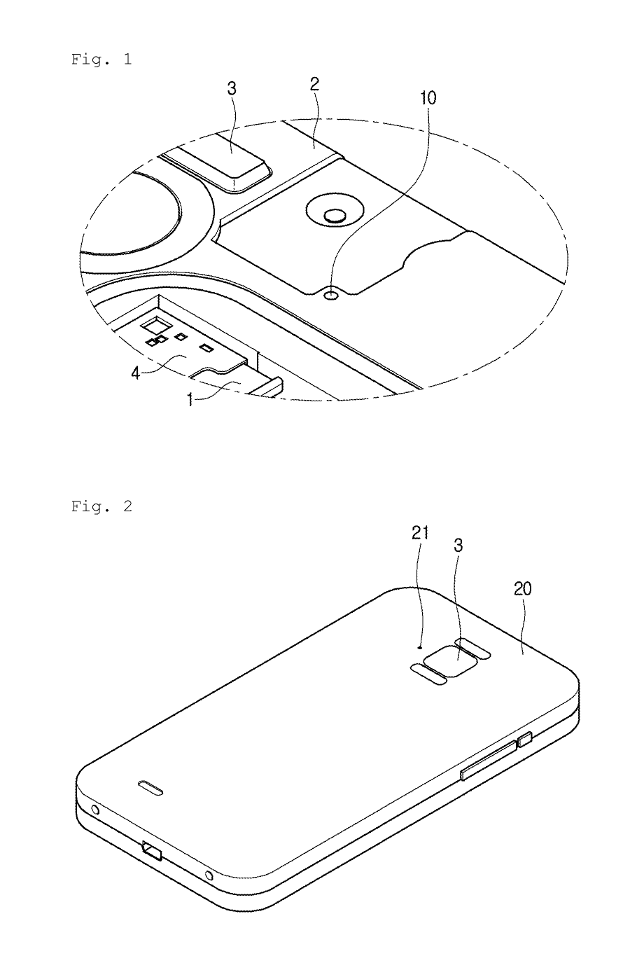

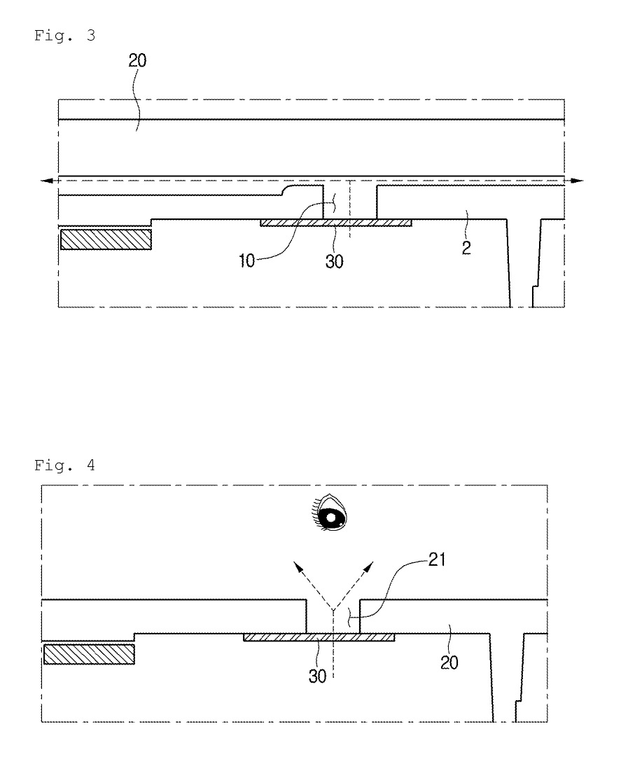

### DETAILED DESCRIPTION OF THE EMBODIMENTS

Reference will now be made in detail to the embodiments.

FIG. 5 is a view of a ventilation structure which is applied to a battery cover of a mobile device having a waterproof function according to an embodiment.

Referring to FIG. 5, a light emitting diode (LED) module 130 provided on a rear surface of a mobile device may be used in a ventilation structure according to an embodiment. When the LED module 130 is mounted on the mobile device to provide a sufficient amount of light while an image is photographed, an LED hole 111 may be defined in a battery cover 110 of the mobile device to expose a portion of the LED module 130.

In the ventilation structure according to the current embodiment, the LED hole 111 may be used to ventilate the inside of the mobile device by an air vent filter 140. That is, the air vent filter 140 allowing air to be ventilated, but preventing moisture from being penetrated may be disposed under the LED module 130. The LED hole 111 may act as an existing air vent hole. In case of the mobile device on which the LED module 130 is mounted, a gap between the LED hole 111 defined in the battery cover 110 and the LED module 130 may act as an air vent hole. Thus, it is unnecessary to form a separate air vent hole.

In the ventilation structure according to an embodiment, the air vent filter 140 is provided under the LED module 130, and a waterproof tape 120 having a ring shape is provided on the LED module 130 to prevent moisture from being penetrated. Also, the waterproof tape 120 having the ring shape may have a sufficient size that is capable of surrounding the LED hole 111 under the battery cover 110. For example, when the LED hole 111 has a circular shape, the waterproof tape 120 may have a circular shape with a width greater than that of a circular shape of the LED hole.

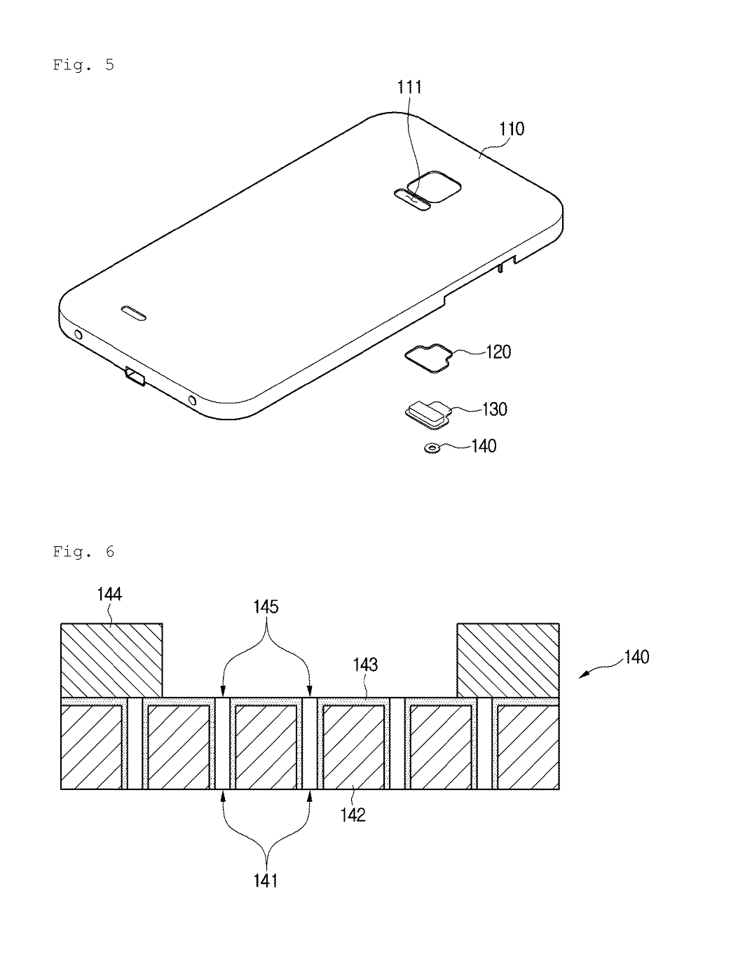

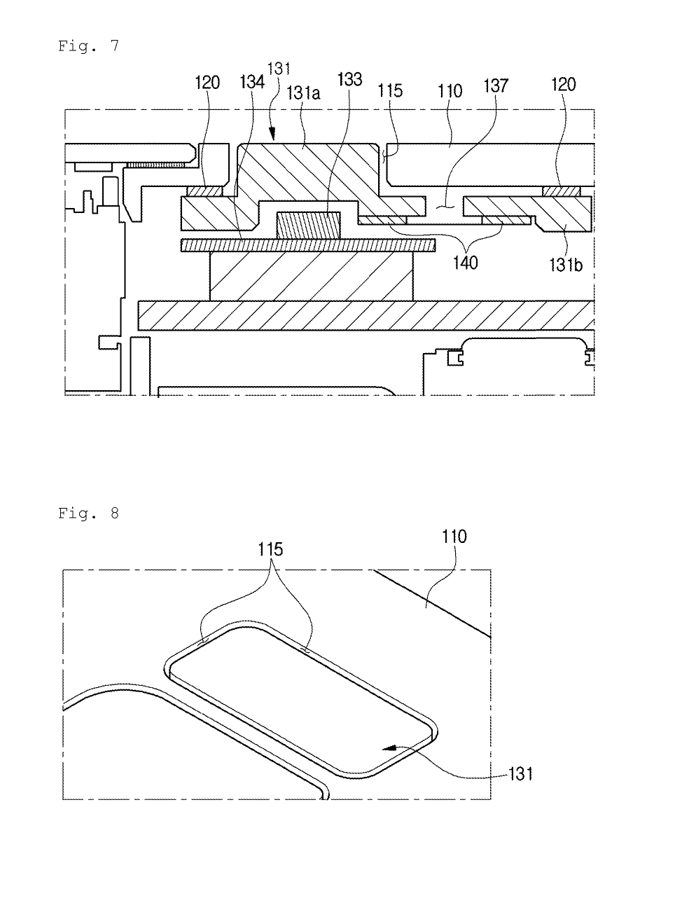

The air vent filter 140 that is applicable to an embodiment will be described with reference to FIG. 6.

FIG. 6 is a view illustrating a structure of an air vent filter that is applicable to the current embodiment.

The air vent filter 140 may allow air to pass therethrough and prevent moisture from being penetrated. The air vent filter 140 may reduce a pressure difference between the inside and the outside of the mobile device.

Referring to FIG. 6, the air vent filter 140 according to an embodiment may be formed of a non-porous resin film 142. The air vent filter 140 includes a processing film 143 disposed on the resin film 142 and a double-sided tape 144 having a ring shape corresponding to that of a peripheral portion of the resin film 142. Here, the non-porous material refers to a content fully filled with a resin.

Although the resin film 142 has a circular or polygonal shape when viewed in a plane, the current embodiment is not limited to the shape of the resin film 142. A plurality of through holes 141 passing through the resin film 142 in a thickness direction are defined in the resin film 142. That is, the plurality of through holes 141 are connected to both surfaces of the resin film 142 in the thickness direction. For example, each of the through holes 141 may be formed by performing an ion irradiating process or an etching process and may have a size of about 0.01μ to about 10μ.

A material for forming the resin film 142 may be a resin that is decomposed by an alkaline solution, an oxidizing agent solution, or an alkaline solution containing an oxidizing agent. For example, the alkaline solution such as potassium hydroxide (KOH) or sodium hydroxide (NaOH) may be used as a solution for hydrolyzing the resin. Also, the resin film 142 in which the through hole 141 is defined may use a membrane filter that is sold by Oxygen Corp. or Millipore Corp.

The processing film 143 disposed on the resin film 142 may be thinly formed to cover only a portion of the through hole 141. Thus, an opening 145 may be defined at a position corresponding to that of the through hole 141. The processing film 143 has hydrophobicity and volatility. A hydrophobic oil repellent agent may be thinly applied on the resin film 142 and be dried to form the processing film 143. For example, a fluorinated coating agent having fluorouracil group may be used as the oil repellent agent.

When the oil repellent agent is applied onto the resin film 142, in which the through hole 141 is defined, and then dried, a second processing film connected to the process film 143 may cover an inner circumferential surface of the through hole 141. In this case, an opening having a size less than that illustrated in FIG. 6 may be defined. Only air may be accessible through the opening, but moisture may be blocked by the opening.

Also, the doubled-surface tapes 144 may be disposed on both sides of the resin film 142, respectively, and the processing film 143 and the opening may be exposed between the doubled-surface tapes 144. An adhesive is applied onto both sides of a base material to form the doubled-surface tape 144. Non-woven fabric formed of PET (Poly Ethylene Terephthalate) may be used as the base material, and an acryl-based adhesive or a silicon-based adhesive may be uses as the adhesive.

The air vent filter 140 having the above-described structure may be fixed to the other member by using the doubled-surface tape 144 and may allow the air to be ventilated through the opening defined in the through hole 141.

FIG. 7 is an enlarged view illustrating the ventilation structure of the mobile device of FIG. 5.

Referring to FIG. 7, the LED module is coupled to the LED hole of the battery cover 110. Only a portion of an upper surface of the LED module may be exposed through the LED hole (shown in FIG. 5).

In a state where the LED module 130 is coupled to the LED hole (shown in FIG. 5), since the battery cover 110 and the LED module are separate members, a gap 115 having a fine size may be defined. In FIG. 8, the battery cover 110 is mounted on the mobile device. Also, in FIG. 8, a portion of an upper surface of an LED lens is exposed through the LED hole (shown in FIG. 5), and the gap 115 is defined between the LED lens 131 and the battery cover 110.

The LED module 130 includes an LED device 133 generating light using electricity, a device support part 134 for supporting the LED device 133 at a lower side of the LED device 133, the LED lens 131 through which the light emitted from the LED device 133 is transmitted, and a lens support part 131b for supporting lower and side portions of the LED lens 131. The lens support part 131b may have a size greater than that of a bottom surface of the LED lens 131. The lens area 131a is disposed on a portion of the lens support part 131b, and a hole for ventilating is defined in the other portion of the lens support part 131b.

It may be unnecessary that the lens support part 131b and the lens area 131a are provided as separate members. For example, a portion of the bottom surface of the LED lens 131 may lengthily extend. For example, the LED lens 131 may include a lens area 131a disposed on the LED device 133 and lens support part(extended area) 131b extending from the lens area 131a and disposed under (inside) the battery cover 110. In this case, a ventilation hole to which the air vent filter is attached may be defined in the extension area. That is, the ventilation hole defined in the extension area may be defined toward the inside of the battery cover 110.

Also, the lens support part 131b of the LED lens 131 may be disposed under the battery cover 110 to surround the LED hole 111. That is, the lens support part 131b may have a size greater than that of the LED hole 111 to prevent the lens area 131a from passing through the LED hole 111. The extension area of the LED lens, i.e., the lens support part 131b may entirely surround the peripheral portion of LED hole 111 to ensure a waterproof seal by using waterproof tape.

Hereinafter, it is explained that the lens support part 131b is disposed to support the LED lens 131. A portion of the lens support part 131b supports the bottom surface of the LED lens 131, and the other portion of the lens support part 131b extends toward the battery cover 110.

The ventilation hole 137 through which the air passes may be defined inside the battery cover 110 in the lens support part 131b. The air vent filter 140 may be mounted on the lower side of the lens support part 131b at a position corresponding to the ventilation hole 137. The doubled-surface tape of the air vent filter 140 may be attached to the bottom surface of the lens support part 131b to fix the air vent filter 140. Also, the air vent filter 140 may be attached so that the openings defined in the resin film of the air vent filter 140 are disposed under the ventilation hole 137.

Also, the waterproof tape 120 for waterproofing the mobile device may be provided between the battery cover 110 and the lens support part 131b so as to prevent moisture that is introduced through the gap 115 defined between the LED lens 131 and the battery cover 110 from being penetrated into the mobile device.

Here, the waterproof tape 120 may be attached to an end of the lens support part 131b to prevent an air moving path through which the air flows inside and outside the mobile device from being blocked by the waterproof tape 120. That is, the waterproof tape 120 may be disposed at the end of the lens support part 131b so that the waterproof tape 120 does not block the path connecting the gap 115 between the LED lens 131 and the battery cover 110 to the ventilation hole 137 defined in the lens support part 131b. In other words, the ventilation hole 137 may be defined in the path connecting the gap 115 to the waterproof tape 120.

In the above-described structure, it may prevent the ventilation hole from being directly exposed to the battery cover 110 or the rear case. Also, the mobile device may have the ventilation and waterproof functions by using the air vent filter 140 and the waterproof function by using the waterproof tape 120.

A method of evaluating the ventilation and waterproof properties with respect to the mobile device having the ventilation structure will be described below.

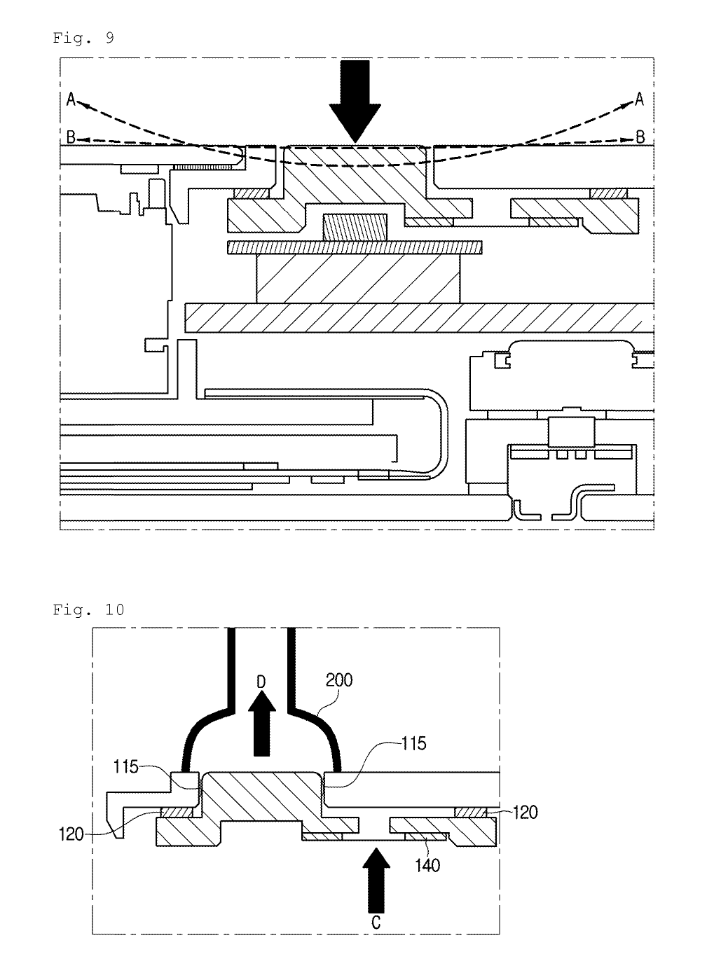

FIG. 9 is a view of a state where a waterproof test is performed on the mobile device.

A waterproof test for a mobile device is performed by applying a high pneumatic pressure into the mobile device within a sealed space and then checking a bended degree of the mobile device.

FIG. 9 illustrates the mobile device to which the ventilation structure of the current embodiment is applied. However, if a waterproof tape is attached to a gap between an LED lens and a battery cover, when the high pneumatic pressure is applied to the mobile device, air may not be introduced into the mobile device. Thus, the mobile device may be bent according to arrow A illustrated in FIG. 9.

However, since the mobile device to which the ventilation structure of the current embodiment is applied has a structure in which air is introduced into the mobile device through the gap and the air vent filter even when the high pneumatic pressure is applied to the mobile device, a bent degree of the mobile device may be substantially reduced as illustrated according to an arrow B.

A method of smoothly performing a waterproof test with respect to the mobile device, to which the ventilation structure according to the current embodiment is applied, by using the existing test equipment is disclosed herein.

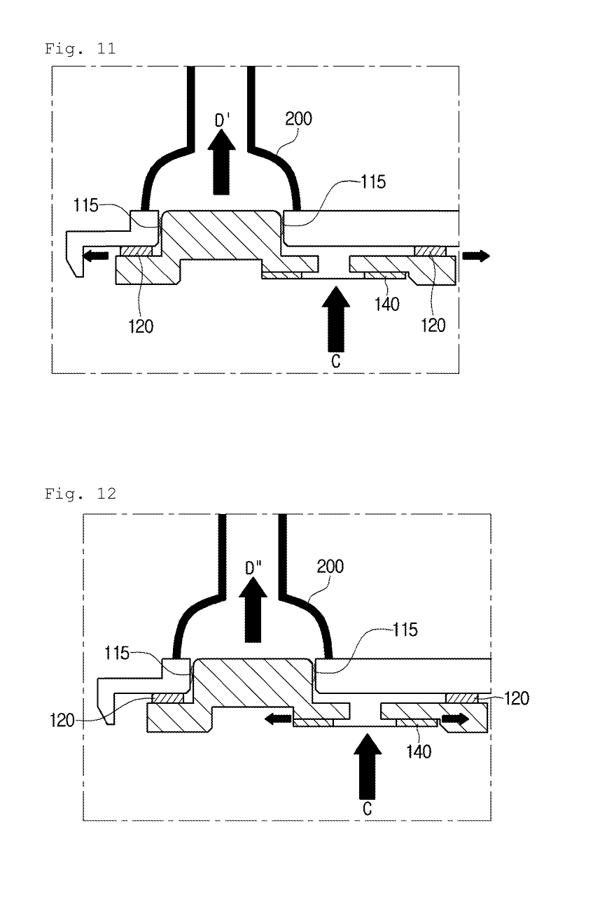

FIGS. 10 to 13 are views illustrating a method of performing a waterproof test with respect to the mobile device having the ventilation structure of the current embodiment.

The waterproof test with respect to the mobile device to which the ventilation structure according to the current embodiment is applied is performed after a ventilation test with respect to the air vent filter and the waterproof tape. When the waterproof test is performed, a process for sealing the gap of the exterior, through which the air is accessible, may be performed first.

Referring to FIG. 10, the ventilation test with respect to the air vent filter 140 and the waterproof tape 120, which are provided in the mobile device, may be performed prior to the waterproof test with respect to the mobile device. The ventilation test may be performed according to the following procedures. An air tube 200 for covering the gap 115 between the LED lens and the battery cover is mounted on the mobile device.

Then, air is introduced to the air vent filter 140 in the mobile device at a point indicated by arrow C. Here, an amount of air discharged through the gap 115 is measured. Since the air vent filter 140 is a member for ventilating the air, if the air vent filter and the waterproof tape have normal performance, an amount of injected air C and an amount of discharged air D may be substantially the same.

However, as illustrated in FIG. 11, if the air flows through the waterproof tape 120 due to the defective waterproof tape 120, an amount of air D′ discharged through the gap 115 may be less than that of air C injected outward from the inside of the mobile device.

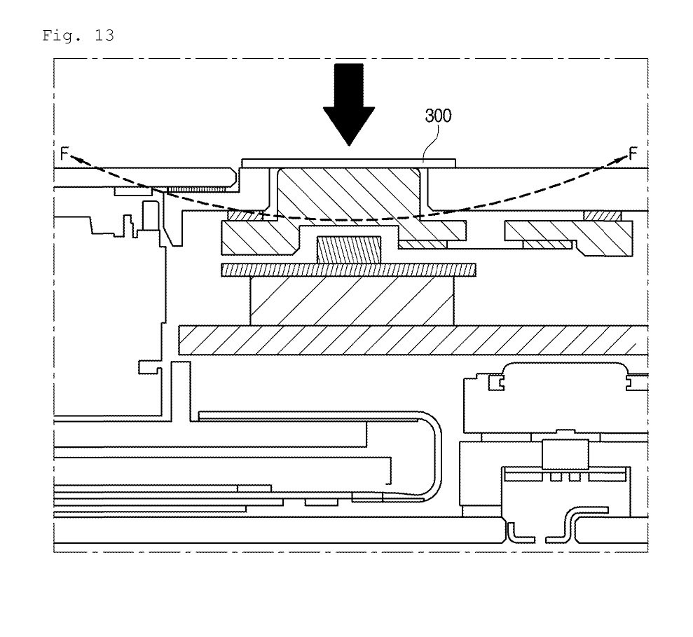

Also, as illustrated in FIG. 12, if a portion of air leaks in one direction of the air vent filter 140 due to a defective air vent filter 140, an amount of air D″ discharged through the gap 115 may be less than that of air C injected toward the air vent filter 140 in the mobile device.

Therefore, in case of the mobile device according to the current embodiment, the air ventilation test may be performed on the air vent filter 140 and the waterproof tape 120. As illustrated in FIG. 10, when the amount of air C injected toward the air vent filter 140 in the mobile device is substantially the same as that of air D flowing through an air tube and discharged from the gap, the waterproof test may be performed.

The waterproof test according to an embodiment may be performed as follows, as illustrated in FIG. 13. A masking tape 300 having a sufficient size that is capable of covering the gap between the LED lens and the battery cover may be used to block the gap. Then, as a general waterproof test, a high pneumatic pressure may be applied toward the mobile device to measure a bent degree F. of the mobile device.

If another hole or gap through which air flows exists in addition to the gap between the LED lens and the battery cover, the bent degree of the mobile device may be small. When the mobile device is completely sealed, the bent degree F. of the mobile device may be steep.

When the bent degree F. of the mobile device is measured, if the bent degree F. is greater than a reference value, it may be determined that the mobile device has passed the waterproof test.

In the foregoing embodiment, although a portion of the LED lens is exposed through the battery cover, and the waterproof tape and the air vent filter are provided under the battery cover, the embodiment is not limited thereto. For example, in case of the battery-integrated mobile device, the rear case may be applied to the idea of the present disclosure instead of the battery cover.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A mobile device comprising:
a light emitting diode (LED) device;
a first cover located over the LED device, wherein the first cover comprises a first top side, an outer edge adjacent to the first top side, and an extension portion which extends from the outer edge wherein the extension portion comprises a first opening;
a second cover comprising a second opening being sized to receive at least a portion of the first cover wherein the second opening includes an inner edge and a gap is formed between the inner edge and the outer edge of the first cover; and
a waterproof barrier located between a top side of the extension portion and a bottom side of the second cover.

2. The mobile device according to claim 1, further comprising an air vent filter located at the first opening, the air vent filter configured to allow air but to prevent moisture from passing through.

3. The mobile device according to claim 1, wherein the extension portion and the first cover are formed of one integrated component.

4. The mobile device according to claim 1, wherein the extension portion extends from the first cover in all directions such that an area of the extension portion exceeds an area of the second opening.

5. The mobile device according to claim 1, wherein the waterproof barrier is configured to surround the second opening underneath the second cover.

6. The mobile device according to claim 5, wherein the waterproof barrier is further configured to surround the second opening underneath the cover.

7. The mobile device according to claim 1, wherein the first cover is configured to allow air to flow between the first opening and the gap.

8. The mobile device according to claim 1, wherein the first opening is the only opening to an interior of the mobile terminal.

9. The mobile device according to claim 1, wherein the location of the first opening and the location of the gap are offset wherein the gap is not positioned above the first opening.

10. A mobile device comprising:
a light emitting diode (LED) device configured to emit light through a first cover;
a battery cover comprising a first opening having a first width, the first opening configured to receive at least a portion of the first cover;
a support portion disposed under the battery cover and configured to support the first cover, wherein the support portion comprises a second opening; a waterproof barrier disposed between a bottom surface of the battery cover and a top surface of the support portion to prevent moisture from passing through; and
an air vent filter located underneath the support portion and configured to allow air to ventilate through the second opening.

11. The mobile device according to claim 10, wherein a gap is defined between the first width and a second width of the at least a portion of the first cover and air is allowed to flow between the gap and the second opening.

12. The mobile device according to claim 10, wherein the waterproof barrier is configured to surround the first opening underneath the battery cover.

13. The mobile device according to claim 12, wherein the waterproof barrier is further configured to surround the second opening underneath the battery cover.

14. The mobile device according to claim 10, wherein an area of the support portion is greater than an area of the first opening.

15. The mobile device according to claim 10, wherein the air vent filter comprises:
a resin film comprising a plurality of passages and a processing film disposed on the resin film.

16. The mobile device according to claim 10, wherein the support portion is configured to extend from a lower portion of the first cover toward the LED device.

17. The mobile device according to claim 10, wherein the second opening is the only opening to an interior of the mobile device.

18. The mobile device according to claim 11, wherein the location of the second opening and the location of the gap are offset wherein the gap is not positioned above the second opening.

19. A waterproof test method for a mobile device comprising a first cover and a light emitting diode (LED) device, the LED device configured to emit light through a second cover wherein the second cover partially protrudes into a first opening of the first cover, the method comprising:
providing an air hose to create a seal against the first cover wherein the first opening is encompassed by the air hose and the air hose is configured to measure an amount of air received by the air hose;
introducing air into an air vent filter located at a second opening of a support portion disposed under the first cover wherein the first opening and the second opening are surrounded by a waterproof barrier provided between a bottom surface of the first cover and a top surface of the support portion and an air pathway is provided between the first opening and the second opening; and
comparing an amount of air injected into the air vent filter with an amount of air received by the air hose to determine an amount of air leaked through the waterproof barrier or the air vent filter.

20. The method of claim 19, further comprising:
attaching a barrier to the first cover to block the first opening;
applying pneumatic pressure having a preset value to the mobile device; and
measuring a degree to which the mobile device is bent in response to the pneumatic pressure.
